(19) United States
(12) Patent Application Publication
(10) Pub. No.: US 2009/0300595 A1
(43) Pub. Date: Dec. 3, 2009

(54) System and Method for Remotely Updating Control Software in a Vehicle With an Electric Drive System

(75) Inventors: Brian Moran, La Mesa, CA (US); Frank Mayer, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 12/130,834

(22) Filed: May 30, 2008

(51) Int. Cl. G06F 9/44

(52) U.S. Cl. 717/170; 717/173

(57) ABSTRACT

A method of remotely updating control software in a heavy-duty vehicle having at least one programmed controller including securing the heavy-duty vehicle; determining that the vehicle is secured; establishing a wireless connection with the heavy-duty vehicle; downloading an updated control software; and updating the heavy-duty vehicle's control software with the updated control software in response to the determining that the vehicle is secured.

### BACKGROUND

1. Field of the Invention

The present invention relates generally to systems and methods for remotely updating control software in a vehicle, and, in particular, a vehicle with a hybrid electric drive system.

2. Related Art

Vehicles increasingly rely on software for control functions such as vehicle control, engine control, and control of other vehicle subsystems. This is especially true for vehicles having electric drive systems (e.g., Electric Vehicles (“EVs”), Hybrid Electric Vehicles (“HEVs”)) because these vehicles are highly dependent on coordinated control of their energy sources, generators/electric motors, power converters, and energy storage. Heavy-duty vehicles including electric drive systems rely even more on software for control functions since these vehicles typically more complex and include additional subsystems requiring control.

New electric drive vehicles and electric drive vehicles first released for testing often require more frequent software updates (e.g., weekly software updates/patches) compared to more mature electric drive vehicles that have been deployed for awhile (e.g., bi-annual software updates/enhancements).

Updating control software on a vehicle can be time-consuming and expensive. Control software updates on a vehicle may also pose unique safety risks. For example, in a standard motor vehicle, a loss of vehicle control may result in catastrophic loss. Moreover, this risk is exacerbated when the vehicle is a heavy-duty vehicle, especially when the heavy-duty vehicle is operated as a common carrier.

Currently, when a vehicle's control software is out of date, either the vehicle must be driven to a service center or a technician must travel to the vehicle in order to update the software on the vehicle. This can be costly, especially if the technician has to fly to the location of the vehicle, and/or if an entire vehicle fleet must be serviced.

Further problems include the requirement of maintaining accurate records for the vehicle and having to accurately monitor the software version of each piece of software residing in each vehicle. When vehicle components are removed or replaced (e.g., using spare parts), these problems are exacerbated because the software version in the records may not accurately reflect the software version of the unit actually installed on the vehicle.

Still further, there are limitations to maintaining uniformity of deployed software versions dependent upon the number of technicians in the field and the rate of updating software.

### SUMMARY

These problems and/or others are addressed by the systems and methods for remotely updating and/or calibrating control software in an electric drive vehicle of the present invention.

An aspect of the invention involves a method of remotely updating control software in a heavy-duty vehicle having at least one programmed controller. The method includes securing the heavy-duty vehicle; determining that the vehicle is secured; establishing a wireless connection with the heavy-duty vehicle; downloading an updated control software; and updating the heavy-duty vehicle's control software with the updated control software in response to the determining that the vehicle is secured.

Another aspect of the invention involves a control software updating device in a heavy-duty vehicle having at least one programmed controller. The control software updating device includes means for determining that the heavy-duty vehicle is secured; a wireless communication module; and a processor configured to update control software in the at least one programmed controller.

A further aspect of the invention involves a system for remotely updating control software in a heavy-duty vehicle having at least one programmed controller. The system includes an indicator configured to indicate that the heavy-duty vehicle is secured; a server configured to provide updated software; a wireless communication link between the heavy-duty vehicle and the server, the wireless communication link configured to communicate the updated software from the server to the heavy-duty vehicle; and a processor configured to update the heavy-duty vehicle's control programming using data transmitted from the server across the wireless communication link when the heavy-duty vehicle is secured.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating over-the-air software updating over a wireless communication network, according to an embodiment of the invention;

FIG. 2 is a block diagram illustrating an exemplary wireless communication module that may be used in connection with the various embodiments described herein;

FIG. 3 is a flow diagram illustrating an exemplary method of updating vehicle software over-the-air;

FIG. 4 is a diagram illustrating an exemplary method of building a software version list;

FIG. 5 is a diagram illustrating an exemplary pull method of updating vehicle software over-the-air;

FIG. 6 is a diagram illustrating an exemplary push method of updating vehicle software over-the-air; and

FIG. 7 is a diagram illustrating an exemplary direct communication method of updating vehicle software over-the-air.

FIG. 8 is a block diagram illustrating an exemplary computer as may be used in connection with the system(s) to carry out the method(s) described herein.

### DETAILED DESCRIPTION

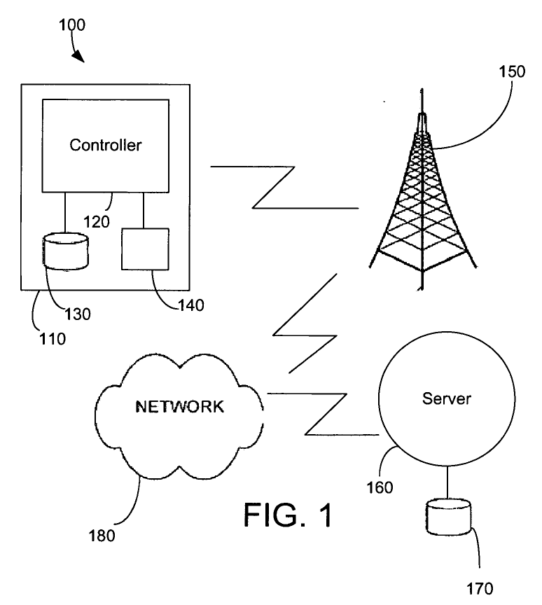

With reference generally to FIGS. 1-8, systems and methods for remotely updating vehicle software, and in particular, control software, in a hybrid or electric drive vehicle in accordance with multiple embodiments of the present invention will be described. In embodiments of the invention, the systems and methods are for updating control software in any vehicle, especially a heavy duty vehicle, requiring periodic control software updates. In more preferred embodiments of the invention, the systems and methods are for updating control software in electric drive vehicles (e.g., HEVs, EVs) requiring periodic control software updates. In most preferred embodiments of the invention, the systems and methods are for updating control software in heavy-duty electric drive vehicles (e.g., heavy-duty HEVs, heavy-duty EVs) requiring periodic control software updates. As used herein, a heavy-duty electric drive vehicle is an electric drive vehicle having a gross weight of over 8,500 lbs. A heavy-duty HEV will typically have a gross weight of over 10,000 lbs. and may include vehicles such as a metropolitan transit bus, a refuse collection truck, a semi tractor trailer, etc.

As used herein, “vehicle software” includes software or modifiable firmware embedded in the vehicle or component. Also, as used herein, “control software” is software executed by a controller(s) to control separate components/systems of the drive train (e.g., Electric Vehicle Control Unit (“EVCU”). Further examples of a controller(s) include(s), but are not limited to, a controller associated with one or more of: engine control, energy storage control, generator control, electric motor control, cooling system control, vehicle control, control of any component that can be flashed over the vehicle communication bus, and control of any component that can be flashed and can communicate across the a vehicle telemetry unit (e.g., Remote Diagnostic Unit (“RDU”)), or any combination thereof.

The systems and methods described herein are applied to a secured vehicle. As used herein, a secured vehicle or “securing a heavy-duty vehicle” may mean affirmatively securing the vehicle, such as physically inhibiting the vehicle or affirmatively indicating that the vehicle is secured. Similarly, “securing a heavy-duty vehicle” may mean passively (constructively) securing the vehicle or otherwise inferring that the vehicle is secured, such as where one condition or state of the vehicle may be used to determine the vehicle is secured. For example a vehicle may be constructively “determined” to be secured based on its Location (e.g., parking lot, designated SW update area, vehicle refueling spot, maintenance/repair facility), the Time/Date (e.g., evenings, weekends, times/dates when vehicle is out of service), and/or a vehicle State/Activity associated with being secure. Examples of a vehicle State/Activity associated with being secure include: Vehicle Off, Parked, Refueling, Key removed, Energy Storage disengaged, and Vehicle at a stop (for quick or non-safety related updates, etc.). For the purposes of this disclosure, “securing the vehicle” is understood as not having a rigid definition, but rather should be viewed in light of the update to be performed and the understanding that certain updates may require more time and/or vehicle inhibition safeguards than other updates.

Updating of the control software in the systems and methods described herein will largely be described as occurring over a wireless connection. As used herein, a “wireless connection” includes, but is not limited to, WWAN, WLAN, Short range radio, etc. In a preferred embodiment, the wireless connection includes a Wireless Wide Area Network (“WWAN”) such as, but not limited to, cellular, GSM, CDMA, and/or GPRS networks. In an alternative preferred embodiment, the wireless connection includes a Wireless Local Area Network (“WLAN”) and wherein the Access Point (AP) is connected to the backend server via the Internet. In a less preferred embodiment, the wireless connection may include a Peer-to-Peer network (e.g., Short range radio based), buffering the update until the vehicle is secure.

Updating of the control software in the systems and methods described herein will be described as being performed by a processor configured to update heavy-duty vehicle's control programming. As used herein a processor configured to update the heavy-duty vehicle's control programming may include a dedicated software update controller on vehicle, a dedicated software update controller on backend server (e.g., at vehicle manufacturer, fleet management facility, maintenance facility, etc.), and/or a multipurpose controller on vehicle (e.g., EVCU, telemetry unit, RDU).

Referring to FIG. 1, a system 100 and method for updating vehicle software, and in particular, control software, in an electric drive vehicle in accordance with an embodiment of the invention will now be described. The system 100 may include a vehicle 110 including an electric drive system, a controller 120, data storage area 130, and wireless communication module 140. System 100 may further include a locally networked connection to the nodes being programmed (or software being updated). According to one embodiment this may be a CAN bus.

The controller 120 may include one or more controllers. For example, updated control software may first be received via a central controller, which is different from the one or more programmed controllers that the heavy-duty vehicle control software is directed toward. Further, the controller 120 may be one or more of at least one main/central vehicle controller, at least one system controller, at least one engine controller, at least one remote diagnostics control system, and/or at least one other vehicle/component controller. An engine controller, a system controller, and a remote diagnostics control system will each be described in turn below.

### Engine Controller

APUs (Auxiliary Power Unit) or energy generation sources may be equipped with advanced automated controllers which help to minimize fuel consumption and emissions while facilitating monitoring and diagnosis of the engine and generator. Certain APU control systems may automatically turn the APU (engine) on and off during vehicle operation. When vehicle power usage is low and there is sufficient energy in the energy storage (e.g., battery pack) to sustain vehicle operation, the APU controller may turn the APU off. The APU is then automatically reactivated when vehicle power requirements increase or the battery energy level begins to run low. Depending on how the APU is programmed, the vehicle can be operated as either a “charge sustaining” or a “charge depleting” hybrid. Alternately, when the APU is on, the APU controller may employ a “load following” technique to tailor APU power output to varying vehicle power needs. During acceleration, hill climbing, and other periods of high power usage, APU power output may automatically be increased to respond to increasing electrical power loads on the generator. When power requirements diminish and these loads are relaxed, APU power output may then be reduced. The controller may also reduce the power output of the APU instantaneously when energy is added to the system by regenerative braking, thereby protecting the drive system from “over-voltage” situations. The flexibility offered by an engine controller enables vehicle power generation to be tailored to different driving cycles or economic situations. For example, in areas with severe emissions problems or high fuel costs, the controller can be programmed to minimize APU run time and to maximize reliance on battery power. Conversely, the APU can be run more often if it is a higher priority to minimize external battery charging or to extend battery life. For APUs utilizing internal combustion engines, the APU controller may also monitor engine health and transmit data on engine temperature, oil pressure, and other key factors to a wireless reporting control unit. The engine controller unit itself may have a form factor of a very small, self-contained microprocessor located in the vehicle APU compartment. Ideally it can be easily diagnosed and removed and replaced by trained service personnel.

### System Controllers

Hybrid and drive control software is an integral part of a hybrid-electric vehicle drive system. The vehicle interface is provided by the vehicle controller, which may be based on a high speed automotive multiplexing system such as J1939. It also provides an interface to displays and standard vehicle electronics such as GPS. CAN (Controller Area Network) bus architecture has been greatly simplified over the years. All major vehicle subsystems (Motive Drive (electric drive motor), APU, Energy Storage, Vehicle Control, and Accessories) may communicate on one single CAN network. This simplifies and improves vehicle data acquisition and maintenance. All major vehicle subsystems can then be accessed via one data port. The computerized control network on the communication bus relies on distribution boxes to monitor, fuse, supply, and/or switch power to high power components.

### Remote Diagnostic System (RDS)

A Remote Diagnostic System (RDS) hardware and software package may provide a reliable, low-cost conduit between the systems on-board a vehicle or in remote locations to operator and maintenance personnel. The RDS comprises a telemetry controller (RDU—Remote Diagnostics Unit) having ability to send commands and set parameters on-board the vehicle. All commands are centrally verified to ensure access by authorized personnel only. The RDS allows the user to control, monitor, diagnose, and analyze advanced vehicles from their desktop computer. For example an engineer can access important engine data, a technician can display fault codes, and a manager can monitor fuel economy—all from the same interface and without worrying about the connection to the vehicle. An on-board data processor (ODP) may also be connected to the vehicle systems (multiplex network), processing all the data into a common format and recording the information to an internal flash drive. Time critical information can be retrieved via the ODP's cellular link.

Each of the abovementioned controllers are programmed to perform their control functions. These controllers are provided for illustration, but are in no way limiting, as there are numerous other controllers on the vehicle.

In operation, in a preferred embodiment, the controller 120 is a central vehicle controller that may configured to compare current software versions with available software versions (e.g., as part of a “pull” technique). As discussed above, examples of a central vehicle controller may include a main system controller, an engine controller, and a remote diagnostics unit). In an alternative embodiment, the individual component/system directly communicates with the server (e.g., as part of a “pull” technique) for available software versions. In a further embodiment, a version listing, or software library, is utilized and may be transmitted from the main central controller 120 onto the server 160. Comparison of current software versions with available software versions may be done on the server 160 (e.g., as part of a “push” technique).

Controller 120 may be further configured to determine that vehicle 110 is secured. Alternately, server 160 may be configured to determine that vehicle 110 is secured. As discussed throughout this disclosure, determining that vehicle is secured may be accomplished through a variety of means. For example, vehicle 110 may be equipped with sensors and/or a user interface that expressly indicate that vehicle is secured. Vehicle 110 may communicate data across, for example, a CAN network, from which it may be inferred that the vehicle 110 is secured. Alternately, controller 120/server 160 may receive information independently from the vehicle (e.g., time, schedule, 3^{rd} party information) that indicates the vehicle is secured.

Continuing to refer to FIG. 1, wireless communication module 140 is in wireless communication with access point 150 through a wireless communication link. Here, the access point is illustrative only and may refer to a variety of wireless communication schemes. Access point 150 is in communication with server 160, which is coupled to data storage area 170, via network 180. The wireless network 180 may be any type of wireless network, such as, but not limited to, a wireless wide area network (“WWAN”), a wireless local area network (“WLAN”), and/or an IEEE 802 wireless network such as an IEEE 802.11 (“WiFi”) network. The wireless network 180 and/or wireless communication link may be part wireless, part wired (e.g., WLAN and Internet).

Wireless communication between the vehicle 110 and the server 160 is preferably via the RDU (or other onboard telemetry controller) and the wireless connection with the server 160 is via a WWAN (e.g., Cell, GPRS, CDMA, GSM). In an alternative embodiment, wireless connection with the server 160 is via WLAN communicatively coupled to the Internet. In a further embodiment, wireless connection with the server 160 is via Peer-to-Peer communication, which is stored or buffered until the vehicle is secured.

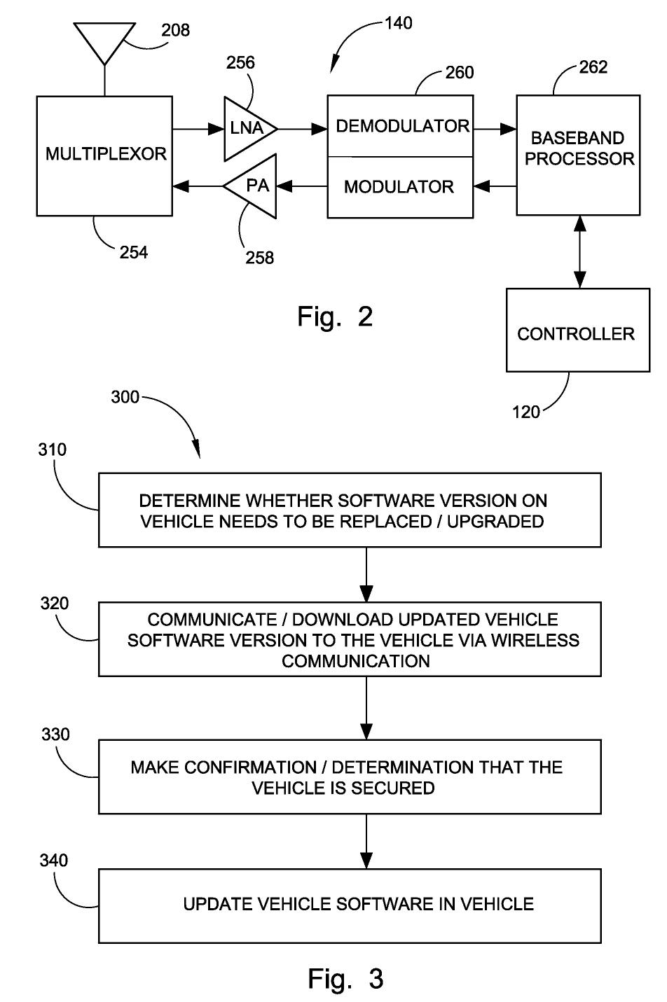

With reference to FIG. 2, an embodiment of a wireless communication module 140 includes an antenna 208 for wireless transmission of data to and from controller 120. In alternative embodiments, other wireless communication devices and/or architectures may also be used, as will be clear to those skilled in the art. In the illustrated embodiment, wireless communication module 140 is used for communication of data and/or audio communications to and from the vehicle 110.

Wireless communication device or module 140 may comprise a multiplexor 254 connected to antenna 208, a low noise amplifier (“LNA”) 256, a power amplifier (“PA”) 258, and a modulation circuit 260 which is connected to baseband processor 262. In the wireless communication device 140, radio frequency (“RF”) signals are transmitted and received by antenna 208. Multiplexor 254 acts as a switch, coupling antenna 208 between the transmit and receive signal paths. In the receive path, received RF signals are coupled from a multiplexor 254 to LNA 256. LNA 256 amplifies the received RF signal and couples the amplified signal to a demodulation portion of the modulation circuit 260.

Typically modulation circuit 260 will combine a demodulator and modulator in one integrated circuit (“IC”). The demodulator and modulator can also be separate components. The demodulator strips away the RF carrier signal leaving a base-band receive signal, which is sent from the demodulator output to the base-band processor 262.

The baseband processor 262 is also communicatively coupled with the controller 120. The controller 120 has access to a data storage area 130, as illustrated in FIG. 1, and is configured to execute instructions (i.e., computer programs or software) that can be stored in the data storage area 130. Software upgrades are received from the baseband processor 262 and may be stored in the data storage area 130, a buffer area, or other data storage area where the software upgrades are installed and/or executed. Such software upgrades, when executed, control functions such as vehicle control, engine control, and control of other vehicle systems.

Referring to FIG. 3, an exemplary method 300 of updating vehicle software over-the-air will now be described. Although the steps in the method 300 are described in a particular order, in alternative embodiments, the steps are performed in different orders than those set forth as illustrated. For example, but not by way of limitation, the “securing step” may be the first step, second step, or other numbered step than that indicated below. Further, the method 300 may have other numbers of steps (e.g., additional steps, fewer steps) or different steps than those indicated below. Also for example, method 300 may include a method of remotely updating control software in a heavy-duty vehicle having at least one programmed controller, the method comprising securing the heavy-duty vehicle, determining that the vehicle is secured, establishing a wireless connection with the heavy-duty vehicle, downloading an updated control software, and updating the heavy-duty vehicle's control software with the updated control software in response to the determining that the vehicle is secured.

According to one embodiment, at step 310, a determination is made on whether the software version on the vehicle 110 needs to be replaced/upgraded (hereinafter “updated”). For example, the method may compare an installed version of controller software with a later or latest version of control software. Thus, when there is a newer version available than what is installed in the vehicle, the older version can be replaced with the newer version. Preferably, when a descriptive software naming convention is used, the comparison may only involve comparing the file names of the software (e.g., <filename_v1>, <filename_v2>).

This version check/determination may include a prioritization of the components/systems to be checked. In particular, the version check/determination may check each software file in a predetermined, prioritized order, or check priority software files more often. For example, safety related and/or vehicle performance related components/systems may have priority over other components/systems. Likewise, priority may be given to units/systems that are more susceptible to updates. Accordingly, the software files associated with the prioritized components/systems may be treated as priority software. Alternately, this version check/determination may set a predetermined schedule of how often the components'/systems' software gets checked. For example, safety related, performance related, and/or items likely to be updated frequently may be scheduled to be checked more often.

According to one embodiment, the vehicle 110/server 160 may check for/receive updates continuously, regularly, and/or real time (without waiting for the vehicle to be secured), but wait to be secured prior to executing the update. The vehicle 110/server 160 may compare what versions the vehicle 110 has with what versions are available. According to one embodiment, whatever system/component has access to the wireless communication module may perform the check.

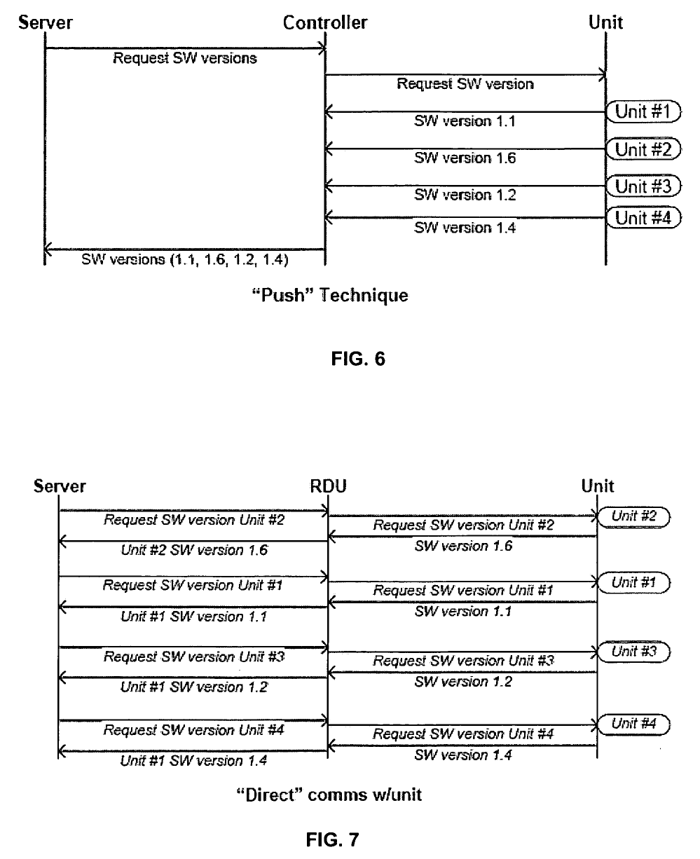

According to one embodiment, this determination may be initiated by the vehicle 110 or from onboard the vehicle. For example FIG. 5 illustrates an exemplary “pull technique” that may initiated from a controller onboard the vehicle. Alternately, this determination may be initiated by the software provider (e.g., vehicle manufacturer) or otherwise from offboard the vehicle. For example FIG. 6 illustrates an exemplary “push technique” that may initiated from a server function offboard the vehicle.

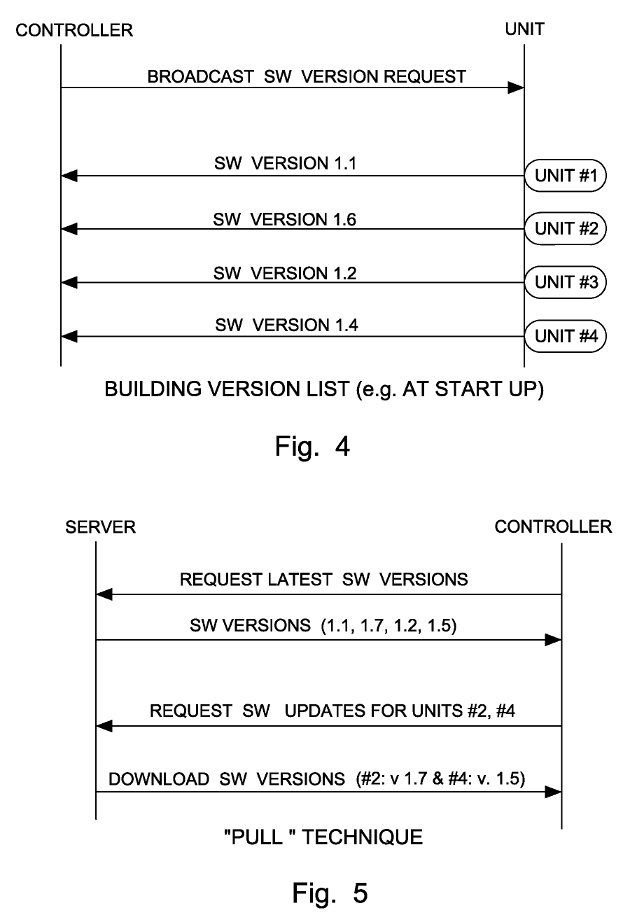

As shown in FIG. 4, in an embodiment where a version listing or software library is used/built, a polling or current software version request is broadcasted by the controller 120 to the units/systems/components of interest, the returned software versions are then received and recorded by the controller 120. This data may be formatted into a machine readable current software version list or software library. According to one embodiment, the latest available software versions may be compared with the software library, and after upgrade is completed, the software library may be again updated. For illustration, in the example shown, Units/Components/Systems #1, 2, 3, 4 indicate to the controller 120 that versions 1.1, 1.6, 1.2, and 1.4 are currently in use. In a preferred embodiment, the version listing or software library is built at the first use of the vehicle. In an alternative embodiment the polling or current software version request is broadcasted at vehicle start up. Building the version list at start up can address the possibility of components being replaced with components having a different software version during, for example, periods when the vehicle is offline.

With reference to FIG. 5, an embodiment of a “pull” technique for over-the-air software upgrades will be described. The controller 120 sends a request to the remote server 160 for the latest software versions and the server 160 reports back that versions 1.1, 1.7, 1.2, and 1.5 are the latest available software versions. Controller may compare the latest available version with those installed on the vehicle. According to one embodiment, a version list/library may have been previously build and stored, as described above, for comparison. In the “pull” technique example of FIG. 5, controller 120 determines that the software versions in Units/Components/Systems #1, 3 are current and that the software versions in Units/Components/Systems #2, 4 are out of date. Accordingly, the controller 120 requests software updates for Units/Components/Systems #2, 4, and these versions are downloaded from the server 160 to the controller 120.

With reference to FIG. 6, an embodiment of a “push” technique for over-the-air software upgrades will be described. The remote server 160 sends a request to the controller 120 for the latest software versions and the controller 120 requests the same from the Units/Components/Systems #1, 2, 3, 4. The Units/Components/Systems #1, 2, 3, 4 report back that versions 1.1, 1.6, 1.2, and 1.4 are the latest available software versions, and this information is transmitted from the controller 120 to the server 160. Alternately, this information maybe previously obtained as part of building a version list, and may be transmitted from controller 120 to server 160. As exemplified, the server 160 may then determine whether any of these software versions are out-of-date, and, if so, sends the latest versions to the controller 120 for updating the software of the appropriate

### Units/Components/Systems.

With reference to FIG. 7, in an alternative embodiment, the individual Units/Components/Systems communicate directly with the server 160 via a RDU. This is more appropriate in a vehicle that does not have a central controller and where the individual Units/Components/Systems use an onboard telemetry unit merely as a communications gateway. As exemplified, the server 160 requests the software version for each Units/Components/Systems directly from the Units/Components/Systems, and the Units/Components/Systems report back the current software version of the Units/Components/Systems. The server 160 then determines whether any of these software versions are out-of-date, and, if so, sends the latest versions to the controller 120 for updating the software of the appropriate Units/Components/Systems.

At step 320, the updated vehicle software version is communicated/downloaded to the vehicle via wireless connection. As discussed above the wireless connection or link may include WWAN, WLAN, Short range radio, etc., and may be integrated with the Internet and an access point. The updated vehicle software version communicated to the vehicle may be stored in a buffer/intermediate storage pending securing of the vehicle. According to one embodiment, the updated vehicle software version may be downloaded to the buffer whenever a good connection is established, and installed later, when the vehicle 110 is secure.

According to one embodiment, the method 300 may include synchronization between download and update. For example, the method may first finish its over-the-air download, make additional determinations (i.e., check integrity of the updated version of control software, configure data storage 130 to be flashed, etc.), then when everything is fine, proceed to update, thus avoiding streaming flash. Synchronization between download and update helps avoid data collisions and installing corrupted data.

At step 330, confirmation/determination is made that the vehicle 110 is secured. Securing the vehicle 110 before and during the vehicle software update is important for safety reasons since some vehicle software updates affect vehicle operation. Determining that the heavy-duty vehicle is secured may include receiving a primary indication from the vehicle 110 that the vehicle 110 is secured. As discussed above, the vehicle may be secured in a variety of ways. For example, the vehicle may be “secured” by placing the vehicle 110 in a “secure” area. Physically secure areas may include, but not by way of limitation, the vehicle's designated parking space in a motor pool yard, a designated over-the-air software update location, a maintenance facility/depot, and any other area where there is an awareness of the update and an expectation that the vehicle will not be operated during the update period.

The vehicle 110 may be expressly identified as being in a secure location. For example, an operator may manually report that the vehicle 110 is secured. Also, the vehicle 110 may report itself as secured through a short range radio or RFID such as where the vehicle 110 must be physically located in the secure area for the self-reporting to trigger and/or operate. With a vehicle 110 having GPS and telemetric capability, such as a RDU-equipped metropolitan transit bus, a remote user/server 160 may also inquire as to the vehicle's location, and upon an acceptable response (i.e., in its designated parking spot), the remote user/server 160 may initiate the software update over-the-air. This embodiment is ideal for a systems integrator desiring to efficiently update its deployed fleet while maintaining positive control over the updates.

According to another embodiment, depending on the degree of the update and the time required, the vehicle 110 may be determined to be “secure” for update upon determining that the vehicle 110 is not in motion, or will not be in motion for a sufficient amount of time. For example, where the software update will not affect the safety of the vehicle 110, and where the time to update the software is of orders of magnitude less than the time to start a stopped vehicle, the vehicle 110 may be determined to be secured by virtue of its being stopped. Similarly, during certain refueling operations (e.g., fuel cell powered hybrids) the refueling process may provide ample time and securing for certain updates.

According to another embodiment, the vehicle 110 is indicated/determined as being “secured” by a secondary indication such as, but not limited to, an indication based on the location of the heavy-duty vehicle, a state or an activity associated with the vehicle being shut down (e.g., override information associated with the vehicle being serviced), a state or an activity associated with the vehicle being detained (e.g., refueling information), and time/date limitations. For example, the vehicle 110 may be considered “secured” when there's no signal from the vehicle ignition, when the vehicle/engine control unit is identified as being in a “standby” mode, when fault conditions are reported such that the vehicle cannot be in operation, and when only GPS being reported by the vehicle telemetry system (i.e., no other vehicle systems are reporting across the CAN network). Similarly, vehicle 110 may be considered “secured” overnight, weekends, or any other time period that the vehicle is scheduled as off-duty or otherwise not being operated. Additionally, vehicle 110 may be considered “secured” based on combinations of time and location information.

At step 340, the control software in vehicle 110 is updated responsive to the determination that the vehicle is secured. As discussed above, the update may be performed via a central controller or the unit/system itself Typically, the update may comprise flashing the unit's/system's programmable memory.

Also, the update may be integrated into the download function, such that downloading and the updating are substantially the same function. This may entail downloading directly to the final memory location. In this case, however, additional steps such as reconfiguring the unit/system/vehicle registers to reflect the change and/or some form of integrity check may also be included.

In an embodiment of the invention, self checks/integrity checks of the new version may occur prior to installing/executing the new version. For example, to determine/indicate the integrity of software received, the updated software may be verified prior to installation using standard checksum, mdssum, cyclic redundancy check (CRC), forward error correction (FEC) techniques. Also, the self checks/integrity checks may include a mechanism for repairing corrupted data prior to install. For example, this may include reconstructing the file using the FEC, or retransmitting the file in response to detecting corruption. If the self checks/integrity checks determine a fault with the new version, the old software version may be kept and the download may be performed again.

As discussed above, updating the software may include factoring in the time it takes to install the new version. For example, a quick update may not require the same level of securing as a longer update. Updating the software may also include factoring whether the update will affect the safe operation of the vehicle. According to one embodiment, the vehicle may be “locked” in the “secure” state (i.e., being prevented from operating) until an update is complete.

Updating the software may include first conditioning/configuring the component/system to receive the new software prior to install. For example, when the RDU (or other central controller) is responsible for managing the software update, the RDU may recognize and command any configurations necessary on the end-recipient unit to receive/install/flash the new software update.

According to one embodiment, one or more reports may be sent by the vehicle 110 when the software updated is completed. For example, the reports may be sent to the vehicle operator, to provider of the software upgrade, and/or to the vehicle manufacturer/integrator Additionally, the one or more report may include transmitting a completion report back to the server 160, reporting on which vehicle 110 updates are completed and/or which updates failed. This reporting may also include indications onboard the vehicle 110 to an operator. For example, they may indicate: (1) that a download trigger has been detected (e.g., there is new software in the buffer and the vehicle is now secured, new updates available, etc.), (2) initiation of download from buffer, and (3) that the download is complete. This onboard reporting may also include an option allowing the operator to initiate or to override the download, or provide warning not attempt to operate the vehicle 110 until the download is complete.

The systems and methods for remotely updating vehicle software over-the-air are advantageous in that the method(s) may be simultaneously performed on a fleet of vehicles at a single time and software updates can be rapidly performed in an efficient, cost-effective, and safe manner.

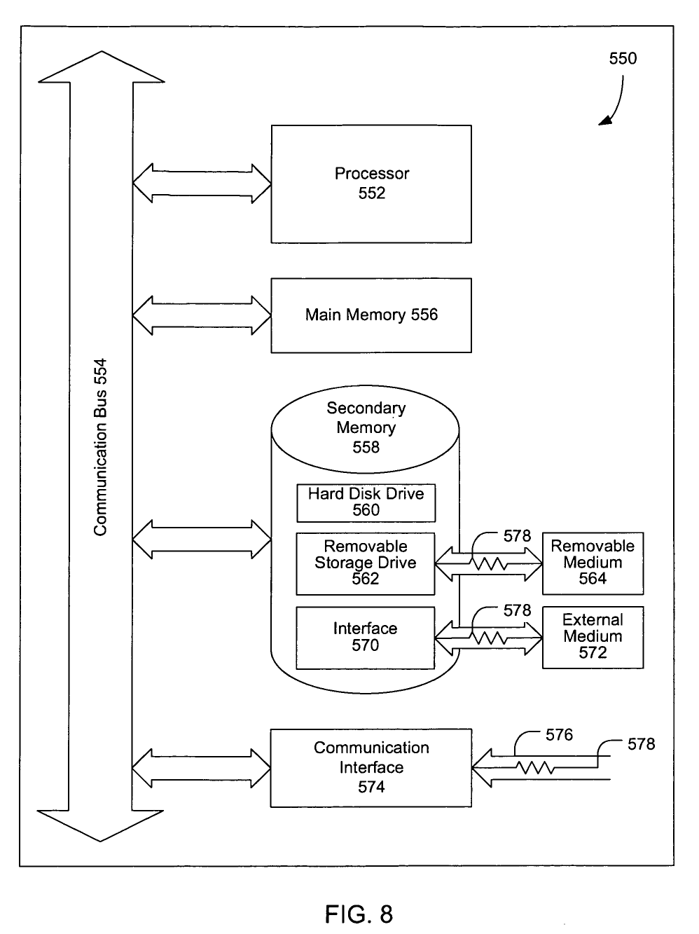

FIG. 8 is a block diagram illustrating an exemplary computer system 550 that may be used in connection with the various embodiments described herein. For example, the computer system 550 (or various components or combinations of components of the computer system 550) may be used in conjunction with the controller 120 and/or other controllers described herein to control the functions described herein. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. technician diagnostic laptops), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof, and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of remotely updating control software in a heavy-duty vehicle having at least one programmed controller, the method comprising:
securing the heavy-duty vehicle;
determining that the vehicle is secured;
establishing a wireless connection with the heavy-duty vehicle;
downloading an updated control software; and,
updating the heavy-duty vehicle's control software with the updated control software in response to the determining that the vehicle is secured.

2. The method of claim 1, wherein the heavy-duty vehicle includes an electric drive system.

3. The method of claim 1, further comprising comparing an installed version of controller software with a later version of control software.

4. The method of claim 3, wherein the comparing the installed version of control software is initiated from onboard the heavy-duty vehicle.

5. The method of claim 3, wherein the comparing the installed version of control software is initiated from offboard the heavy-duty vehicle.

6. The method of claim 1, wherein the securing the heavy-duty vehicle comprises physically securing the heavy-duty vehicle.

7. The method of claim 1, wherein the determining that the heavy-duty vehicle is secured comprises receiving a primary indication that the vehicle is secured.

8. The method of claim 1, wherein the determining that the heavy-duty vehicle is secured comprises receiving a secondary indication, which is associated with a condition of the vehicle that is also associated with the vehicle being secured.

9. The method of claim 8, wherein the secondary indication comprises a location of the heavy-duty vehicle; and,
wherein the determining that the heavy-duty vehicle is secured is based on the location of the heavy-duty vehicle.

10. The method of claim 8, wherein the secondary indication comprises a state or an activity associated with the vehicle being shut down.

11. The method of claim 10, wherein the state or the activity associated with the vehicle being shut down comprises a time or a date information associated with the vehicle being out-of-service.

12. The method of claim 10, wherein the state or the activity associated with the vehicle being shut down comprises an override information associated with the vehicle being serviced.

13. The method of claim 8, wherein the secondary indication comprises a state or an activity associated with the vehicle being detained.

14. The method of claim 13, wherein the state or the activity associated with the vehicle being detained comprises a refueling information.

15. The method of claim 1, wherein the establishing the wireless connection with the heavy-duty vehicle comprises establishing the wireless connection with an access point communicatively coupled to the Internet.

16. The method of claim 1, wherein the downloading the updated control software and the updating the heavy-duty vehicle's control software are substantially the same function.

17. The method of claim 1, wherein the downloading the updated control software further comprises receiving and storing a latest version of control software prior to the determining that the vehicle is secured.

18. The method of claim 1, wherein the downloading the updated control software comprises confirming the integrity of the updated control software transmission.

19. The method of claim 1, wherein the updating the heavy-duty vehicle's control software comprises confirming the integrity of the updated control software.

20. The method of claim 1, wherein the downloading the updated control software comprises downloading the updated control software via a central controller different from the at least one programmed controller; and,
wherein the updating the heavy-duty vehicle's control software comprises the central controller configuring the at least one programmed controller to receive the updated control software.

21. The method of claim 1, further comprising limiting functionality of the heavy-duty vehicle during the updating the heavy-duty vehicle's control software.

22. A control software updating device in a heavy-duty vehicle having at least one programmed controller, the control software updating device comprising:
means for determining that the heavy-duty vehicle is secured;
a wireless communication module configured to receive an updated control software;
a processor configured to update control software in the at least one programmed controller responsive to determining that the heavy-duty vehicle is secured.

23. A system for remotely updating control software in a heavy-duty vehicle having at least one programmed controller, the system comprising:
an indicator configured to indicate that the heavy-duty vehicle is secured;
a server configured to provide updated software;
a wireless communication link between the heavy-duty vehicle and the server, the wireless communication link configured to communicate the updated software from the server to the heavy-duty vehicle;
a processor configured to update the heavy-duty vehicle's control programming using data transmitted from the server across the wireless communication link when the heavy-duty vehicle is secured.

24. The system of claim 23, wherein the wireless communication link between the heavy-duty vehicle and the server includes an intermediate network comprising at least a WLAN and Internet.

25. The system of claim 23, wherein the at least one programmed controller includes the processor.

26. The system of claim 25, further including a telemetry system controller other than the at least one programmed controller including the processor.
